(19) United States
(12) Patent Application Publication
(10) Pub. No.: US 2003/0148253 A1
(43) Pub. Date: Aug. 7, 2003

(54) Interactive, delayed revelation, educational method and system

(76) Inventors: William J. Sacco, Bel Air, MD (US); D. Michael Navin, Bel Air, MD (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/340,427

(22) Filed: Jan. 10, 2003

Related U.S. Application Data
(60) Provisional application No. 60/347,271, filed on Jan. 10, 2002.

(51) Int. Cl. G09B 7/00

(52) U.S. Cl. 434/322

(57) ABSTRACT

The present invention is an educational method and system that teaches analytical and mathematical methods and concepts using multimedia based, open-ended, real world case studies and an experiential, interactive, self-paced, self-discovery instructional pedagogy. Students are challenged to find solutions to real world problems. Then students are directed toward efficient solution methods based upon an evaluation of their answer, or upon an evaluation of their description of their problem solving method. The evaluation of the student's response determines a degree of assistance provided. Assistance, or hints, are provided, each tailored to provide a pre-determined degree of help directed to how to address the challenge, or how to more efficiently address the challenge, to better understand the problem. Accordingly, the teaching methodology of the present invention leads students to a discovery of solution strategies, rather than showing or lecturing the students about the solutions or the solution strategies.

### RELATED APPLICATIONS

This application claims benefit of U.S. Provisional Application Serial No. 60/347,271, filed Jan. 10, 2002, entitled “An Interactive, Delayed Revelation, Educational Method and System,” which is incorporated in its entirety by this reference.

### FIELD OF THE INVENTION

The present invention relates generally to educational methods and systems, and more particularly to methods and systems teaching analytical and mathematical methods and concepts On-line, using multimedia based, open-ended, real world case studies having experiential, interactive, and self-paced instructional pedagogy where students are led to a self-discovery of optimal problem solving methods and solutions.

### BACKGROUND OF THE INVENTION

Many educational and cognitive psychology researchers believe that learning should revolve around an understanding and promotion of thinking rather than upon a memorization of rules. Open-ended challenges, meaningful (engaging) learning contexts, collaborative learning, and an active, student-centered classroom where students learn to make decisions, are among the best teaching practices. In such a learning model, basic skills are acquired through a process of solving meaningful problems. Researchers have noted an excitement about learning and solving challenging problems when learning occurs in this model, and when the model enhances continuing and increased problem solving persistence, creativity, self-concept and interpersonal skills.

Many teachers have neither the training nor the resources to provide this type of learning experience. A very small percentage of the workplace has been exposed to experiential learning, and much of the workforce suffers from accumulated educational deficiencies in acquiring needed competencies and foundation skills. Critical thinking is a valuable life skill, but requires instruction and practice to cultivate.

In the book, The Schools Our Children Deserve, author Alfie Kohn states that “analysts of NAEP [National Assessment of Educational Progress] data for the Educational Testing Service observed that students can ‘recite rules’ but often don't ‘have any idea whether their answers are reasonable.’ The ‘preposterous answers’ that often result can be attributed to ‘a general overemphasis in contemporary curricula on computation-related skills or the tendency to teach skills and knowledge before integrating applications and problem solving into instruction.’” Kohn further states that practicing skills without understanding offers little benefit to successful students and makes unsuccessful students feel more incompetent as they fall further behind in understanding. Kohn cites a number of studies and research from the United States and around the world that supports changes in the educational model.

Learning is a complex human activity. In the publication, “What we Know About How Children Learn,” Dr. Dale Rose Baker states that “[l]earning is the ability to know both how, procedural knowledge, and what, factual and conceptual knowledge, to learn. Learning is the ability to transfer our knowledge to new situations to solve problems. Learning is the ability to monitor our own thinking, referred to as metacognition, so that we can identify what we don't understand about a task and apply another strategy to insure completion of the task.”

Memorizing facts and doing drills may help with acquiring factual and procedural knowledge, but it doesn't facilitate developing conceptual knowledge and understanding, which allows knowledge to become “a tool which can be used in new situations to solve novel problems . . . .” Factors identified by Dr. Baker, and other researchers, to facilitate learning include:

Student centered instruction where teachers stop becoming lecturers and demonstrators and start becoming facilitators and managers of the learning environment that provides open ended activities where multiple solutions are possible and “that promotes inquiry, student-to-student interactions, group work and problem solving.”

Learning by doing, and instruction that challenges intuitive student conceptions about the world and how it works.

Curriculum that provides a meaningful context for learning

Providing time and activities that allow students to think about what they already know and how to relate it to what they are currently doing, what they understand or what confuses them. Having students reflect on and communicate this helps develop metacognition.

Mathematical thinking is a key element in developing problem solving and thinking skills. According to the National Council of Teachers of Mathematics (NCTM), mathematical thinking “opens doors to productive futures.” There is a lack of appreciation and confidence in learning and using math. Traditional math curriculums feature many concepts and methods having limited use in the workplace. Many “real world” examples provided by traditional mathematics teachers are not grounded in workplace applications and experiences, thereby exacerbating skepticism about the relevance of math and mathematical thinking to real world problems. An aversion to math sometimes results, which can create a filter affecting a further study of math and science for many students, thereby adversely affecting the problem solving and thinking abilities of students and workers, as well as the flow of workers into scientific and technical fields.

Many critical thinking courses are philosophically based, rather than experientially based. These courses describe what is and needs to be done, as opposed to providing “how to” examples and application based experiences.

For the foregoing reasons, there is a need for educational methods and systems providing open-ended challenges, meaningful learning contexts, collaborative learning, and an active student-centered, or interactive, learning environment where students learn to make decisions. There is a need for an educational model that develops continuing and increased problem solving persistence, creativity, self-concept and interpersonal skills.

Furthermore, traditional educational models are limited by fixed schedules, and teacher, classroom, and curriculum constraints. In addition, traditional educational models are primarily directed to those in the early stages of their life, rather than to adults with workplace challenges. Distance learning opportunities have overcome some of the limitations of traditional educational models, but have not been able to capture high quality in pedagogical content and delivery, and have not been able to provide an interactive environment directed to leading students to discover solution strategies, rather than lecturing students about certain processes. For the foregoing reasons, there is a need for educational methods and systems available “on-demand”, so that students of all ages and capabilities can reap the benefits of an interactive, self-paced, open-ended experiential learning environment where students develop problem solving skills by solving problems.

### SUMMARY OF THE INVENTION

The present invention is an educational method and system directed to maximizing learning retention by leading students to discover problem solving methods on their own, and to increase their appreciation of and confidence in using mathematical thinking. The present invention educates, on-demand, by offering real world case studies, featuring a curriculum of powerful and widely useful problem solving methods, presented through video and/or animation, which challenge students with open-ended problems. The present invention is based upon the belief that students become problem solvers by solving problems in an interactive format, where creativity and persistence lead to problem solving discoveries.

The present invention educates by providing open-ended challenges, and then by assisting the student, as needed, in addressing the challenge. Leading questions are asked, or hints are given, to assist the student in creating, discovering, re-inventing, remembering, or learning the problem solving methods, rather than just being given the problem solving instruction. The assistance offered is reactive to the student's approach to the challenge, often forces rethinking, and encourages the student to apply more sophisticated problem solving techniques. Tutorials and assessments (e.g., testing) are also provided, as needed, to help solve the challenge and/or gauge student understanding. The assessments could serve to qualify the student for a diploma, certification, license, or continuing education credit. Additional case studies, pointers, and tips are provided to facilitate the transfer of learning to other applications, to gain experience, and to stimulate further use and continued research and learning.

In one aspect of the present invention, an educational method presents one or more students with a question, eliciting one or more answers to the question. The one or more answers received from the students are evaluated and the students are then provided with assistance in answering the question. The type or amount of assistance provided is determined based upon the evaluation of the one or more answers.

The question could require any of a variety of responses, such as a multiple choice selection, or a numeric or narrative entry in an answer field. The question might also ask the student to describe the technique the student would use to answer the question, rather than asking for the answer to the question.

The evaluation of the one or more answers to the question could ascertain whether the answer is correct, or could determine a degree to which the answer is correct. In the latter event, the type or amount of assistance provided could be relative, or based upon, the degree to which the one or more answers are correct. The evaluation could involve a keyword search for pre-detennined characters in the answer field, where the pre-determined characters are terms or numbers selected as indicative of a quality of the one or more answers.

The assistance provided could be in the form of a leading question, or a hint, or a question specific to only a particular aspect or feature of a problem solving method applicable to the question. In either event, the assistance provided helps the student better understand the problem, or to consider the problem from a different perspective, or is directed to assisting the student to think of or self-discover a problem solving approach to the question, or a better problem solving approach to the question, without explicitly revealing the problem solving approach to the student. Or, the assistance provided could be in the fonm of a tutorial directed to the optimal problem solving method applicable to answering the question, or some aspect of the optimal method.

In another aspect of the present invention, an educational method presents one or more students with one or more open-ended case studies, each case study challenging the one or more students with at least one problem to solve, eliciting the students to interactively provide one or more answers to the problem, or one or more solution methods for solving the problem. The problems are selected to invoke a study of one or more pre-determined analytical problem solving skills. The students are then interactively provided with an evaluation of the one or more answers to the problem, or the one or more solution methods for solving the problem. The one or more case studies could experientially challenge the one or more students with real world workplace problems to solve.

In another aspect of the present invention, an educational method provides one or more students with access to an internet based, application-oriented curriculum. The students are presented with one or more open-ended case studies, where each case study challenges the students with at least one problem to solve, the problem selected to invoke a study of one or more pre-determined analytical or mathematical problem solving skills. The case studies could be presented, or recreated, through video and/or animation. Upon receiving, from the students, one or more answers to the problem, or one or more solution methods for solving the problem, the present invention provides the students with problem solving assistance. The assistance helps lead the students to a determination of a correct solution to the problem or to an optimal problem solving method. The type or degree of assistance provided is determined based upon an evaluation of the one or more answers to the problem, or the one or more solution methods provided for solving the problem, as received from the students.

In another aspect of the present invention, the analytical problem solving skills could be selected from the group consisting of data analysis, optimization (including linear programming), probability, statistics, algebraic modeling, graph theory, indices, systems theory, graphic representation, decision theory, information science, math programming, management science, simulation, operations research, and quantitative methods. The problem solving skills could also be selected from a group consisting of EmpowerMath⁷⁵⁻⁹⁰™ and Critical Thinking⁷⁵⁻⁹⁰™ concepts.

### BRIEF DESCRIPTION OF THE DRAWINGS

For the purpose of illustrating the invention, there is shown in the drawing one embodiment of the present invention; it being understood, however, that this invention is not limited to the precise arrangements and instrumentalities shown.

FIG. 1 is a flow diagram illustrating an exemplary embodiment of an educational method in accordance with the present invention.

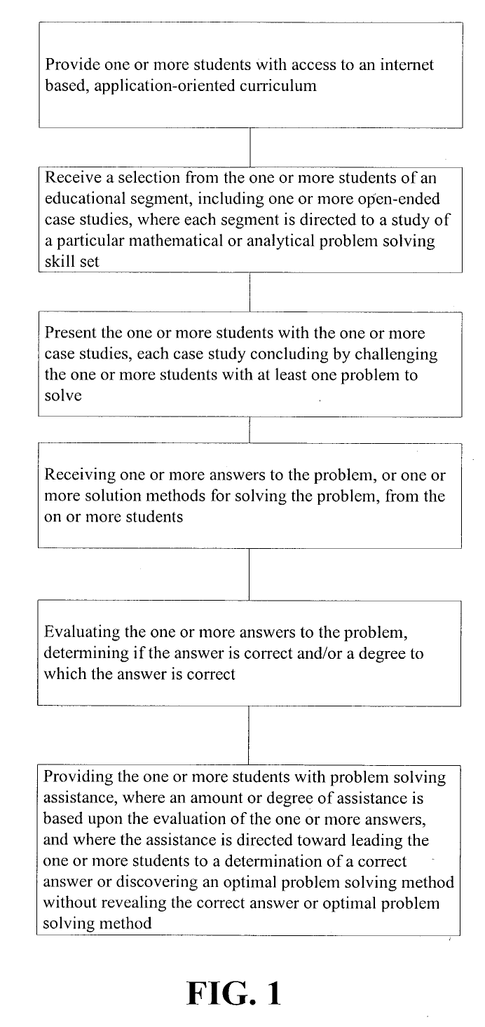

### DETAILED DESCRIPTION OF THE INVENTION

The present invention provides an innovative curriculum of applied mathematics and problem solving instruction, through advanced delivery technology, to create and motivate critical thinkers to apply simple math and powerful problem solving techniques in real world situations. Further, the present invention enables students to know when and how to use the problem solving techniques in real world situations through use of interactive, real world case studies.

The teaching methodology of the present invention is based on a belief that students become problem solvers by solving problems. Thus, the present invention presents open-ended, real world problems (e.g., by VHS, DVD, or the Internet), providing students with data and challenging the students to find solutions to problems on their own, or in collaborative teams, as the students will do in real world situations, such as the workplace. Then, and as necessary, the present invention nudges or directs the students toward problem solutions by assisting the students in developing problem solving strategies, or developing more efficient problem solving strategies.

Each case study introduces a challenge, and provides students with help or assistance in addressing the challenge, or how to more efficiently address the challenge. A degree of assistance provided is determined by an evaluation of the student's response to the challenge, or to the student's response to queries directed to the challenge. The teaching methodology of the present invention is referred to as “delayed revelation”, which leads students to solution strategies, rather than showing or lecturing the students about particular solutions or about processes leading to the solutions.

The pedagogy of the present invention features:

active and student centered learning experiences;

real workplace problems (case based learning) and meaningful contexts for learning;

instruction and curriculum that engages and motivates students to think, to value learning and to be more aware of careers and the need to develop and hone necessary skills, and to overcome psychological barriers to learning math and to learning in general;

providing teachers with the resources to challenge, instruct and support their students and to grow professionally;

integration: students simultaneously acquire required workplace competencies and skills, and important academic knowledge;

collaborative learning: teachers use a pedagogical strategy that emphasizes collaborative learning and written and oral student presentations;

open-ended problems: only after students have been challenged, either alone or collaboratively, to come up with their own solutions, are the students directed to the solutions. This technique, referred to as “delayed revelation”, invites students to think critically and to become invested in the learning experience;

assessment: students can assess their progress; and

information technology is employed to create interest in the classroom, realistic scenarios, deliver instruction, and as a tool to carry out solutions.

For the corporate training opportunity, the present invention provides:

speed to performance: specific application to business situations and critical issues;

blended delivery via instructor led classroom and/or individualized online learning;

SCANS competencies and foundation skills support: In addition to supporting important math concepts and standards, five out of the eight workplace skills and competencies identified by the Department of Labor Secretary's Commission on Achieving Necessary Skills (SCANS) are directly addressed by the present invention. Mastery of these areas is considered necessary in order for workers and the U.S. to be competitive in the 21^{st} Century global workplace. The areas directly addressed include:

1. Thinking Skills: ability to learn, to reason, to think creatively, to make decisions, and to solve problems

2. Basic Skills: basic math, reading, speaking and listening skills

3. Resources: allocating and optimizing materials and costs, and detecting inefficiencies

4. Interpersonal Skills: working on teams, teaching and learning from others

5. Information: organizing and evaluating data, interpreting and communicating orally and in writing, and using computers to process and transform data into understandable, useful and actionable information.

The Curriculum of the present invention includes:

EmpowerMath⁷⁵⁻⁹⁰™ and critical Thinking⁷⁵⁻⁹⁰™

EmpowerMath⁷⁵⁻⁹⁰™ and Critical Thinking⁷⁵⁻⁹⁰™ is a curriculum of the 75 analytical concepts used in solving 90% of problems in the workplace. These concepts represent a most useful analytical approach to business today. Accordingly, the list of concepts can change as new analytical methods are advanced or adopted, and as new business paradigms come into play. While these are the bellwether methods to solve problems of various types, settings and industries, most are straightforward, and most of even the most powerful algorithms require only arithmetic skills to understand. The 75 analytical concepts are cross-disciplinary, and reflect the top methods from operations research and applied mathematics. EmpowerMath⁷⁵⁻⁹⁰™ and Critical Thinking⁷⁵⁻⁹⁰™ include concepts from the fields of data analysis, optimization (including linear programming), probability, statistics, algebraic modeling, graph theory, indices, systems theory, graphic representation, decision theory, information science, math programming, management science, simulation, operations research, and quantitative methods.

The curriculum of the present invention represents the most important and applicable concepts from courses and books that take semesters and years of study. The curriculum “skims the cream” from courses and books and presents it in a way that allows students to understand and use key concepts in hours, rather than months and years of study. This, and the opportunity to apply these methods to specific critical issues, accelerates the application of powerful methods to the workplace and the resulting benefits in performance.

Case Study Based Learning

The present invention uses multimedia to recreate real world case studies that place students in the middle of problems from various industries and workplace settings. Those employing the present invention not only learn the most widely used and powerful problem solving methods across many analytical disciplines, but also gain the equivalent of 3 to 5 years of actual problem solving experience through use of the case studies from various workplace settings. Students learn when and how to use these methods to become resourceful problem solvers. A distinct competitive advantage of the present invention is a focus on case studies, where students not only learn techniques to solve problems, but gain the experience needed to recognize problem solving opportunities.

Instructional Philosophy—Delayed Revelation

Students are first placed in the middle of real problems, and are challenged to create solution strategies on their own. Questioning is then structured for students to discover weaknesses in their problem solving strategies, hopefully leading them to an “aha”, and enabling them to revise their problem solving methods. Ultimately, each problem leads the student to a tutorial on the preferred method(s) for solving the problem. By the time the tutorial is invoked, students are vested in the problem, and ready to learn. Also, by the time the tutorial is invoked, students have attempted the problem, or certain aspects of the problem, one or more times, and have been prompted, based upon an evaluation of their attempt(s) at the problem, to explore more precise or efficient solution methods to the problem. This process is called “Delayed Revelation”, which maximizes learning retention. As students continue facing new problems, they increase their knowledge of EmpowerMath⁷⁵⁻⁹⁰™ and CriticalThinking⁷⁵⁻⁹⁰™ concepts, and ultimately become adept at choosing the best techniques for problems in many contexts, and become experienced and efficient problem solvers.

Products of the Present Invention

The product philosophy of the present invention is to provide learning experiences characterized as:

the most widely-used and most widely applicable mathematics in the world;

taught in meaningful contexts of compelling real world problems;

open ended challenges in a student centered learning environment; and

delivered through exciting multimedia presentations.

By way of example, one open ended challenge is directed to:

a video sequence which begins with a critically ill newborn being flown via helicopter to be placed on a heart lung bypass machine. After learning details of the medical condition, students see and hear from Dr Billie Short, Chief of Neonatology at Children's Hospital in Washington D.C. who is interested in bringing this therapy to her hospital. Because of risks with heart lung bypass she wants to treat babies with less than a 20% chance of survival. Since she doesn't know how to determine this, she hires a researcher and provides him with data on 30 seriously ill infants, 16 who died and 14 who lived. The same data is provided to the students, and the students are challenged to determine a method for predicting which babies have a 20% chance of survival. This real world problem teaches applications of exploratory data analysis techniques.

The collection of compelling problems such as the above are case studies coming from various industries and workplace settings, and from journals and books.

The products of the present invention are geared towards creating effective problem solvers and critical thinkers. To be a good problem solver, one must have the tools to solve problems, and one must be able to recognize problem solving opportunities. The tools are provided through the EmpowerMath⁷⁵⁻⁹⁰™ and Critical Thinking⁷⁵⁻⁹⁰™ curriculum. The ability to recognize problem solving opportunities is gained through problem solving practice, provided through a case study based, experiential product line.

Product Lines of the Present Invention

The present invention can be presented in multiple formats, such as case study presentation on videotape, with associated hard copy materials, or in an Online format.

The videotape series: is an extensive, multi-part case study series with learning experience materials structured for collaborative learning in a classroom setting. Packages include teacher and student materials, blackline masters, correlation to national standards, and software. By way of example, the following four learning experiences encompass nineteen (19) EmpowerMath⁷⁵⁻⁹⁰™ and Critical Thinking⁷⁵⁻⁹⁰™ concepts.

ECMO: A Problem of Life and Death:

See the italicized description above. This product includes optional virtual conversations software that enables students to interactively interview the medical doctor through voice recognition technology.

Every Second Counts—A Race to the Fire:

Fire and emergency transport sets the stage for students to learn important math concepts from the field of optimization as they seek the quickest route in a street network, and eventually extend this to facility location problems. Concepts include Greedy algorithms, decision trees, and Dijkstra's method, the best known method for solving this type of routing problem.

Paramedics and Probability:

The 1987 Amtrak train crash in Chase, Md., sets the stage for students to make triage decisions, and evaluate the injured. Students hear from paramedics who were at the scene as they learn indices, scoring models, probability, and graphical analysis techniques. As one teacher said in a focus test of this series: “I will never look at another accident scene the same way again!”

Linear Programming Paves the Way:

Students are challenged to find a better mix of raw materials to make asphalt. They learn how a young analyst, fresh out of college, applied linear programming to this problem and saved his company $1000 per day. Linear programming is the most powerful and widely used concept in the world for solving large problems involving the efficient allocation of scare resources.

The Online series: provides individual, interactive, multimedia problem solving on the Internet. Students are presented with open-ended challenges, and are led to discover solutions at a pace dictated by the student, through evaluation of the student's responses to certain problems. Every student ultimately is lead to a fully animated tutorial on solving the problem at hand. By way of example, the Online series addresses the following components:

Solve A Problem—initially includes, but is not limited to, 15 open ended real world case studies, encompassing at least 25 concepts from EmpowerMath⁷⁵⁻⁹⁰™ and Critical Thinking⁷⁵⁻⁹⁰™, that challenges students to create and invent solutions: For example, students are challenged to:

schedule college make-up exams such that no student has a conflict;

determine the best location for a new facility;

find the cheapest layout of a wide area network for sharing inter-hospital information;

analyze cost & probability data to determine the best sites to drill for oil.

Test Your Knowledge—short assessments that test students' grasp of problem solving methods from the EmpowerMath⁷⁵⁻⁹⁰™ and Critical Thinking⁷⁵⁻⁹⁰™ curriculum. The assessments are predominantly multiple choice questions which and test the student's knowledge of the mechanics and use of problem solving methods.

Review a Method—fully animated tutorials on EmpowerMath⁷⁵⁻⁹⁰™ and Critical Thinking⁷⁵⁻⁹⁰™ concepts. Students see the mechanics of using a method and typically see an application. These tutorials provide a refresher or act as an online reference for field support.

Toolkits—downloadable software to analyze or graph data, and solve problems.

A Business Application BrainStorm—a live interactive online classroom, facilitated by the present invention through existing online classroom software, with a client company's students discussing the application of EmpowerMath⁷⁵⁻⁹⁰™ and Critical Thinking⁷⁵⁻⁹⁰™ concepts to that company's workplace. The goal is to identify opportunities for immediately implementation of concepts from the brainstorm.

By way of example, the following illustrates Online case studies concluding with an open-ended problem. Each case study is self-paced and interactive. Each includes tutorials explaining a preferred solution method for the problem, as well as including questions testing student comprehension of the method. Each case study can be facilitated by software capable of providing assistance, or hints, or the algorithm for solving the problem. Upon evaluation of the student's response to the problem, the student is offered variations of information, perhaps through hints or leading questions, that is reactive to the student's present approach to the problem, thereby forcing rethinking and encouraging discovery of new solution strategies, or the use of the EmpowerMath⁷⁵⁻⁹⁰™ and Critical Thinking⁷⁵⁻⁹⁰™ concepts previously learned.

ECMO: Newborn Hope

Students use real medical data to decide which severely ill newborns should receive risky, but potentially lifesaving, therapy. Students learn to organize and compare data sets using stem leaf diagrams, box plots, and scattergrams.

ECMO II: Newborn Hope

Students create a testing strategy for a heroic therapy that could save the lives of newborns. Students learn the benefits and risks of a balanced randomized design test and the probability-based adaptive design test. Students learn simple and conditional probability as they grapple with ethical vs. scientific issues.

The Great Cover Up

Students find the least expensive way to cover 10 plants with covers of three different sizes in this clever disguise for a real-life military problem. Students learn how to use a combinatorial analysis to distinguish between exhaustion and dynamic programming as the best method for solving problems.

AZT: The Wonder Drug?

Students determine the best testing strategy for the AIDS drug AZT. Students learn the procedures for the balanced randomized design test and the probability-based adaptive design test, and see how math can be at the heart of controversy.

Scoring for Life

Students create indices using arithmetic and normalization to score the injuries of trauma patients. Using the Injury Severity Score as a model, students are given examples of injured patients to test their indices, and learn how hospitals core their patients.

Taking it to the Hoop

Students create indices using arithmetic and normalization to score the performance of the NCAA basketball tournament seeding committees. Students answer questions featuring exciting basketball footage and evaluate results to test and refine their indices.

Networking Your Health

Students find the least expensive way to connect hospitals with a wide area network. Questions lead students to “discover” the Kruskal method—simple algorithm using order in and arithmetic.

Schedule This!

Students schedule make-up exams for 20 students in 10 different subjects so that no student has a conflict. Questions lead students to “discover” a solution using a chromatic number algorithm—a simple method using number ordering and arithmetic.

Fighting Time

Students find the best location for a new firehouse. Students compare their method for finding the location to the Dijkstra method—an efficient method that uses addition and ordering to find the quickest route from one location to all other locations.

Searchfor Oil

Students identify the best order to drill several different sites for oil. Questions demonstrate the advantages of the ‘bang for the buck’ method as well as the computation of average cost. Students see how these methods apply to medical diagnosing and even auto repairs.

Air Tragedy: Surviving the Crash

Students create a method to measure the difference in the injury assessment data between passengers that survived and those that died in a plane crash. Interesting data from an actual plane crash is used to help students apply exploratory data analysis techniques to the data sets. Tutorials explaining stem leaf diagrams, box plots, and the overlap measure are included along with a second chance to use each.

Power

Students create an emergency plan that distributes electricity from one Texas city to seven others. Following a tutorial on the Dijkstra method, students are given a second chance to create a plan using this efficient method that requires only arithmetic operations.

Securing the Nation

Students schedule security guards at a top secret government facility so that the least number of guards can be hired. Students use algebraic notation to model the problem. The best model is a very interesting algebra representation. Linear programming is introduced as the preferred method for solving the problem. Hints and LINDO software are provided to help students model and solve the problem.

Paving the Way

Students create a mix of raw materials to make asphalt that meets government constraints and costs less than all other such mixes. After becoming familiar with the mixing process and requirements, students model the problem through algebra, and are introduced to linear programming through a tutorial. After the tutorial, students formulate a linear programming problem and download LINDO software to solve it.

Insuring Your Success

Students decide how to hire employees and assign them to jobs within an insurance company in a way that maximizes the expected return on those newly hired employees. Students typically apply a trial and error process, before they are led to steepest ascent algorithm and dynamic programming, both of which require arithmetic, ordering and numerical methods.

An Exemplary Embodiment of the Present Invention

Upon log-on to the online system, the student is presented with a real world case study, such as one of the examples noted above. The case study presents the student (through video, text, and/or animation) with background facts (such as statistics, rules, or constraints) and challenges the student with an open-ended problem. The student is first asked to solve the problem independently, receiving no instruction directed to a problem solving method. The student may be asked for an answer to the problem, or may be asked to describe the method the student intends to use to solve the problem. If asked to answer the problem, the student might be provided with a multiple choice selection, or might be asked to enter a number answer, or might be asked to draft a brief narrative. If prompted for a description of an intended method of problem solving, the student could provide a more lengthy narrative, of perhaps a sentence or paragraph in length. At various times during a problem solving exercise, the student is provided with a link, or with the capability, to review the previously presented background facts.

The present invention then electronically evaluates the student's response. If the student was required to enter, as a response to a question, one or more words or numbers in a narrative answer field, the present invention employs software capable of locating pre-determined terms or numbers in the answer field, each selected as indicative of a certain level of knowledge regarding the problem or question at hand. For instance, a certain term or number found in the narrative may indicate that the student is very close to, or far from, a correct answer, or whether the student is knowledgeable about and has chosen to employ the optimal or most efficient method available to solve the problem. Essentially, in addition to evaluating whether a student response is correct, the present invention evaluates a degree of correctness (i.e., the present invention attempts to determine how incorrect the student's response is).

By evaluating how far the student is from a correct answer, or how far the student is from understanding and choosing an optimal problem solving method, the present invention then determines what additional information would best help the student realize or discover which problem solving method is most applicable, or most optimal, to the problem at hand, or what additional information would help the student realize how to carry out the most applicable problem solving method to arrive at a best answer. So, the type or degree of assistance provided is tailored to the need of the student, based upon the quality of the student's answer. This educational approach causes students to discover or invent progressively improved problem solving approaches, leading to the best known method for solving the problem, rather than just being taught or shown the best known method and asked to apply it.

The present invention provides the additional information, or problem solving assistance, in the form of a hint, or a leading question, or a question specific to a particular aspect or feature of the problem solving method, the assistance allowing the student to think of or discover a problem solving approach, or a better problem solving approach, almost by revelation. Upon responding to the specific or leading question, the student may receive additional assistance with that question based upon an evaluation of the answer provided. Or, the student may simply be given the answer to the leading question, or taught the lesson intended by the leading question. After receiving the applicable assistance, the student again addresses the initial challenge. Ultimately, after closing in on the correct answer, or after determining the correct answer, or even if the student never closes in on the correct answer, the student is provided with a complete tutorial directed to the optimal method for solving the problem.

Course Currieulum and the Present Invention

The content of the present invention is flexible and can be organized and delivered in a number of ways to suit a variety of needs and audiences. The videotape and Online products are used in academic and corporate training markets as projects, as supplemental and enrichment courses, as training and development courses for teachers and workers or as full semester courses in math, critical thinking (general education) and career school programs. The full semester courses have been adapted for college level credit, and for advanced level college credit for high school students. The appeal of the present invention extends from elementary, middle, and high school students, to at-risk youth and vocational education students, to gifted and talented students, to all aspects of the workplace, including sophisticated analysts who want to refresh and expand their knowledge of powerful problem solving methods. Blended delivery options include classroom led and self-instruction.

The composition of modules is flexible, as case studies are independent and can be swapped in and out in support of various curriculum packaging schemes. The first modules for the corporate sector are organized by industry/field, with case studies either from that industry/field or including concepts with particular relevance to that industry/field, by business function or process and workplace skill. The case studies can be organized into product modules including manufacturing, health and medicine, transportation; communications, general business problem solving, business efficiency, human resources, and manpower and resource planning.

An Exemplary Course Curriculum Outline

By way of example, the following is a specific course outline including six segments. The segments can be teacher-led in the classroom and/or self-directed by the students on the Internet.

Learning Experience 1: A Problem ofLife and Death—The ECMO Saga

A four part series focusing on exploratory data analysis and modeling to decide which newborn babies should receive heart-lung pump therapy. Students use medical data from 30 babies to predict which babies have less than a 20% change of survival. The four parts progressively present more information and more clues to the solution of the problem presented. Students are introduced to stem-leaf diagrams, box plots, scattergrams, decision regions, methods for testing medical therapies, and the international controversy over these methods

Learning Experience 2. Seconds Count: A Race to the Fire

A five part series focusing on real applications of quickest route problems. Students analyze and draw conclusions from traffic data to find the quickest route to a fire scene, and to determine a best location for a new facility. Students are introduced to problem solving methods including trial and error, greedy, global inspection, exhaustion, branch and bound, and Dijkstra.

Learning Experience 3: Paramedics and Probability

A five part series focusing on real-life applications of trauma and pre-hospital patient management. Students analyze trauma data and prioritize patient care as they are challenged to make triage decisions and evaluate hospital care. Students learn actual methods used by EMTs to evaluate victims, and are introduced to modeling, indexing, probability, standardization, regression/curve fitting, smoothing, and double functioning labels.

Learning Exp. 4: Mine Y our Business—Linear Programming Paves the Way

A six part series focusing on the incredible saga of a 22 year-old college graduate who experiences immediate success as an employee of a road construction company. Students are challenged to do what he did, to first find a feasible mix of materials, and then an optimal mix, requiring the students to model the problem algebraically and to use software to solve it. Students are introduced to algebraic notation, the formulation of linear programming models, linear inequalities, constraints, objective functions, feasibility, corner principle, and sensitivity analysis.

Learning Experience 5: 911—A Math Emergency in the ICU!

Students are challenged to recreate Dr. John Siegel's landmark research that could revolutionize trauma patient treatment in Intensive Care Units throughout the world. Students are introduced to state vectors, normalization, clustering, glyphs, curve fitting, probability, distance between two points, averages, standardization, mapping, and stochastic dynamic programming.

Learning Experience 6—Problem Solving

Additional case studies, if desired, are presented, some using analytical concepts encountered in the previous five learning experiences. Others introduce new concepts in the context of transportation, medicine, business, economics, and military problems. Students gain practice in facing varied problems and applying concepts in new contexts.

A Second Exemplary Course Curriculum Outline

A series of one day, continuing education courses have been developed to teach practical methods of problem solving and critical thinking. The courses are available in the classroom, entirely on-line, or in a blended learning format, with each course structured as a 6-8 hour class. Students gain problem solving experience and expertise as they face actual workplace case studies. Video and animation is used to set the stage for students as they analyze data and create and invent solutions to open ended workplace challenges. Students then are led to discover simple, practical, and powerful problem solving methods from statistics, decision theory, optimization, exploratory data analysis, and simulation. These methods have wide application across industries and workplace settings.

Practical Problem Solving and Critical Thinking for the Workplace

The following family of seminars strengthen 4 essential skill areas for today's workplace. Each are designed to improve decision making, as well as to enhance reasoning and analytical skills. Each seminar includes a subset of Critical Thinking⁷⁵⁻⁹⁰™, the 75 analytical methods used in solving 90% of the problems faced in the workplace.

Exploratory Techniques for Displaying, Summarizing and Modeling Data

In the information age, people are confronted with an ever-increasing amount of data that needs to be transformed into understandable, useful and actionable information. Students face four case studies as they learn graphical analysis techniques including box plots, scattergrams and glyphs, and learn analysis techniques such as decision regions.

Detecting Workplace Inefficiencies

There is no question that problem solving skills are valuable in the workplace, but perhaps an even more valuable skill is the ability to detect areas for improvement where there are no apparent problems. Students face four case studies as they use such concepts as search theory to minimize diagnosis of production line failure times, dynamic programming to minimize product mix costs and simulation to optimize overall process times.

Efficient Resource Allocation

The workplace is all about managing physical, financial, and human resources, and efficiently utilizing these resources leads to increased competitiveness, enhanced customer and worker satisfaction, and improved productivity/profitability. Students face three case studies as they learn linear and integer programming, sensitivity analysis and learn how to mathematically model and solve real world problems using Lindo Linear Programming software.

Structured Approaches to Decision Making

Decision making in the workplace is often complex. A logical and structured framework can improve problem understanding and decision-making results. This course leads students to three useful methods with wide applications. Students face three case studies as they learn techniques helpful in making decisions including analytical hierarchy process and decision trees.

The 2 courses below take methods from the Critical Thinking⁷⁵⁻⁹⁰™ curriculum and apply them to Allied Health, Nursing and First Responder fields.

Practical Problem Solving and Critical Thinking for Nursing and Allied Health

Students face medical and non-medical cases that feature methods useful for diagnosing medical conditions, analyzing medical data, and reducing sentinel events including search theory, anatoglyphs, and exploratory data analysis techniques. This course is ideal for hospital managers/department heads, nurse practitioners, and quality improvement personnel who are looking to improve their problem solving skills.

Practical Problem Solving and Critical Thinking for First Responders

First Responders face triage situations including two mass casualty situations as they learn triage and trauma scoring methods, Injury Severity Score, Revised Trauma Score, START scoring, and survival probability modeling.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention.

What is claimed is:

1. An On-line educational method, comprising the steps of:
presenting one or more students with a question;
receiving one or more answers to the question;
evaluating the one or more answers; and
providing the one or more students with assistance in solving the problem, wherein a type or amount of assistance provided is determined based upon the evaluation of the one or more answers.

2. The method of claim 1, wherein the question presented requires the student to enter a narrative answer in an answer field.

3. The method of claim 2, wherein the narrative answer is directed to describing a method the one or more students would employ to solve the question.

4. The method of claim 1, wherein the question presented requires the student to enter a numeric answer in an answer field.

5. The method of claim 1, wherein evaluating the one or more answers involves determining a degree to which the one or more answers is correct.

6. The method of claim 5, wherein the type or amount of assistance provided is relative to the degree to which the one or more answers is correct.

7. The method of claim 1, wherein evaluating the one or more answers involves performing a keyword search for pre-determined characters in an answer field.

8. The method of claim 7, wherein the pre-determined characters are terms or numbers selected as indicative of a quality of the one or more answers.

9. The method of claim 7, wherein the pre-determined characters are terms or numbers selected as indicative of a degree to which the one or more answers is correct.

10. The method of claim 1, wherein the assistance provided is in the form of a leading question.

11. The method of claim 1, wherein the assistance provided is in the form of a hint.

12. The method of claim 1, wherein the assistance provided is directed to assisting the student to create or self-discover a problem solving approach to the question, or a better problem solving approach to the question, without revealing the problem solving approach.

13. The method of claim 1, wherein the assistance provided is a tutorial directed to an optimal problem solving method for answering the question.

14. An On-line educational method, comprising the steps of:
presenting one or more students with one or more open-ended case studies, each case study challenging the one or more students with at least one problem to solve, the problem selected to invoke a study of one or more pre-determined analytical problem solving skills;
interactively receiving one or more answers to the problem, or one or more solution methods for solving the problem, from the one or more students; and
interactively providing the one or more students with an evaluation of the one or more answers to the problem, or the one or more solution methods for solving the problem, received from the one or more students.

15. The method of claim 14, wherein the problem solving skills are selected from the group consisting of data analysis, optimization (including linear programming), probability, statistics, algebraic modeling, graph theory, indices, systems theory, graphic representation, decision theory, infonnation science, math programming, management science, simulation, operations research, and quantitative methods.

16. The method of claim 14, wherein the problem solving skills are selected from the group consisting of EmpowerMath⁷⁵⁻⁹⁰™ and Critical Thinking concepts.

17. The method of claim 14, wherein the evaluation of the one or more problems is an assessment directed to gauging performance and understanding.

18. The method of claim 17, wherein the assessment serves to qualify the one or more students for a diploma, certification, license, or continuing education credit.

19. The method of claim 14, further comprising the step of providing the one or more students with additional information, pointers, or challenges directed to further or different problem solving applications of the one or more analytical problem solving skills.

20. The method of claim 14, wherein the one or more case studies experientially challenge the one or more students with a real world workplace problem to solve.

21. The method of claim 14, further comprising the step of interactively providing the one or more students with problem solving assistance, leading the one or more students to a determination of a correct answer or optimal problem solving method.

22. The method of claim 21, wherein a degree of assistance provided is determined based upon the evaluation of the one or more answers to the problem, or the one or more solution methods for solving the problem.

23. An On-line educational method, comprising the steps of:
providing one or more students with access to an internet based, application-oriented curriculum;
presenting the one or more students with one or more open-ended case studies, each case study challenging the one or more students with at least one problem to solve, the problem selected to invoke a study of one or more pre-determined analytical or mathematical problem solving skills;
interactively receiving one or more answers to the problem, or one or more solution methods for solving the problem, from the one or more students; and
interactively providing the one or more students with problem solving assistance, leading the one or more students to a determination of a correct solution or optimal problem solving method, wherein a degree of assistance provided is determined based upon an evaluation of the one or more answers to the problem, or the one or more solution methods for solving the problem, received from the one or more students.

24. The method of claim 23, wherein the problem solving skills are selected from the group consisting of data analysis, optimization (including linear programming), probability, statistics, algebraic modeling, graph theory, indices, systems theory, graphic representation, decision theory, information science, math programming, management science, simulation, operations research, and quantitative methods.

25. The method of claim 23, wherein the case studies are recreated through video and/or animation.

26. A computer readable medium that configures a computer to perform an educational method, the method comprising the steps of:
presenting one or more students with a question;
receiving one or more answers to the question;
evaluating the one or more answers; and
providing the one or more students with assistance in answering the problem, wherein a type or amount of assistance provided is determined based upon the evaluation of the one or more answers.

27. A computer readable medium that configures a computer to perform an educational method, the method comprising the steps of:
presenting one or more students with one or more open-ended case studies, each case study challenging the one or more students with at least one problem to solve, the problem selected to invoke a study of one or more pre-determined analytical problem solving skills;
interactively receiving one or more answers to the problem, or one or more solution methods for solving the problem, from the one or more students; and
interactively providing the one or more students with an evaluation of the one or more answers to the problem, or the one or more solution methods for solving the problem, received from the one or more students.

28. A computer readable medium that configures a computer to perform an educational method, the method comprising the steps of:
providing one or more students with access to an internet based, application-oriented curriculum;
presenting the one or more students with one or more open-ended case studies, each case study challenging the one or more students with at least one problem to solve, the problem selected to invoke a study of one or more pre-determined analytical or mathematical problem solving skills;
receiving one or more answers to the problem, or one or more solution methods for solving the problem, from the one or more students; and
providing the one or more students with problem solving assistance, leading the one or more students to a determination of a correct solution or optimal problem solving method, wherein a degree of assistance provided is determined based upon an evaluation of the one or more answers to the problem, or the one or more solution methods for solving the problem, received from the one or more students.

29. A computer readable medium that stores a program for performing an educational method, the program comprising:
means for presenting one or more students with a question;
means for receiving one or more answers to the question;
means for evaluating the one or more answers; and
means for providing the one or more students with assistance in answering the problem,
wherein a type or amount of assistance provided is determined based upon the evaluation of the one or more answers.

30. A computer readable medium that stores a program for performing an educational method, the program comprising:
means for presenting one or more students with one or more open-ended case studies, each case study challenging the one or more students with at least one problem to solve, the problem selected to invoke a study of one or more pre-determined analytical problem solving skills;
means for interactively receiving one or more answers to the problem, or one or more solution methods for solving the problem, from the one or more students; and
means for interactively providing the one or more students with an evaluation of the one or more answers to the problem, or the one or more solution methods for solving the problem, received from the one or more students.

31. A computer readable medium that stores a program for performing an educational method, the program comprising:
means for providing one or more students with access to an internet based, application-oriented curriculum;
means for presenting the one or more students with one or more open-ended case studies, each case study challenging the one or more students with at least one problem to solve, the problem selected to invoke a study of one or more pre-determined analytical or mathematical problem solving skills;
means for receiving one or more answers to the problem, or one or more solution methods for solving the problem, from the one or more students; and
means for providing the one or more students with problem solving assistance, leading the one or more students to a determination of a correct solution or optimal problem solving method, wherein a degree of assistance provided is determined based upon an evaluation of the one or more answers to the problem, or the one or more solution methods for solving the problem, received from the one or more students.
